(19) United States
(12) Patent Application Publication
(10) Pub. No.: US 2021/0160507 A1
(43) Pub. Date: May 27, 2021

(54) SYSTEMS AND METHODS FOR ADAPTIVELY CLIPPING SAMPLE VALUES

(71) Applicants: SHARP KABUSHIKI KAISHA, Sakai City, Osaka (JP); FG Innovation Company Limited, Tuen Mun, New Territories (HK)

(72) Inventors: SEUNG-HWAN KIM, Camas, WA (US); JIE ZHAO, Camas, WA (US); KIRAN MUKESH MISRA, Camas, WA (US); CHRISTOPHER ANDREW SEGALL, Camas, WA (US)

(73) Assignee: SHARP KABUSHIKI KAISHA, Sakai City, Osaka (JP)

(21) Appl. No.: 16/338,454

(22) PCT Filed: Aug. 21, 2017
(86) PCT No.: PCT/JP2017/029756

§ 371 Date: Mar. 29, 2019

(30) Foreign Application Priority Data
Oct. 4, 2016 (US) 62404190
Oct. 18, 2016 (US) 62409836

(51) Int. Cl. H04N 19/132; H04N 19/96; H04N 19/176; H04N 19/46; H04N 19/85

(52) U.S. Cl. CPC H04N 19/132; H04N 19/96; H04N 19/85; H04N 19/46; H04N 19/176

(57) ABSTRACT

This disclosure relates to video coding and more particularly to techniques for adaptively clipping sample values of video data. According to an aspect of an invention, a sample value limit is determined for one or more sub-divisions of the video data and a bound of a clipping function is set based on the determined sample value limit.

### CROSS REFERENCE

This Nonprovisional application claims priority under 35 U.S.C. § 119 on provisional Application No. 62/409,836 on Oct. 18, 2016, and provisional Application No. 62/404,190 on Oct. 4, 2016, the entire contents of which are hereby incorporated by reference.

### TECHNICAL FIELD

This disclosure relates to video coding and more particularly to techniques for adaptively clipping sample values of video data.

### BACKGROUND ART

Digital video capabilities can be incorporated into a wide range of devices, including digital televisions, laptop or desktop computers, tablet computers, digital recording devices, digital media players, video gaming devices, cellular telephones, including so-called smartphones, medical imaging devices, and the like. Digital video may be coded according to a video coding standard. Video coding standards may incorporate video compression techniques. Examples of video coding standards include ISO/IEC MPEG-4 Visual and ITU-T H.264 (also known as ISO/IEC MPEG-4 AVC) and High-Efficiency Video Coding (HEVC). HEVC is described in High Efficiency Video Coding (HEVC), Rec. ITU-T H.265 April 2015, which is incorporated by reference, and referred to herein as ITU-T H.265. Extensions and improvements for ITU-T H.265 are currently being considered for development of next generation video coding standards. For example, the ITU-T Video Coding Experts Group (VCEG) and ISO/IEC (Moving Picture Experts Group (MPEG) (collectively referred to as the Joint Video Exploration Team (JVET)) are studying the potential need for standardization of future video coding technology with a compression capability that significantly exceeds that of the current HEVC standard. The Joint Exploration Model 3 (JEM 3), Algorithm Description of Joint Exploration Test Model 3 (JEM 3), ISO/IEC JTC1/SC29/WG11 Document: JVET-C1001v3, May 2016, Geneva, CH, which is incorporated by reference herein, describes the coding features that are under coordinated test model study by the JVET as potentially enhancing video coding technology beyond the capabilities of ITU-T H.265. It should be noted that the coding features of JEM 3 are implemented in JEM reference software maintained by the Fraunhofer research organization. Currently, the updated JEM reference software version 3 (JEM 3.0) is available. As used herein, the term JEM is used to collectively refer to algorithm descriptions of JEM 3 and implementations of JEM reference software.

Video compression techniques enable data requirements for storing and transmitting video data to be reduced. Video compression techniques may reduce data requirements by exploiting the inherent redundancies in a video sequence. Video compression techniques may sub-divide a video sequence into successively smaller portions (i.e., groups of frames within a video sequence, a frame within a group of frames, slices within a frame, coding tree units (e.g., macroblocks) within a slice, coding blocks within a coding tree unit, etc.). Intra prediction coding techniques (e.g., intra-picture (spatial)) and inter prediction techniques (i.e., inter-picture (temporal)) may be used to generate difference values between a unit of video data to be coded and a reference unit of video data. The difference values may be referred to as residual data. Residual data may be coded as quantized transform coefficients. Syntax elements may relate residual data and a reference coding unit (e.g., intra-prediction mode indices, motion vectors, and block vectors). Residual data and syntax elements may be entropy coded. Entropy encoded residual data and syntax elements may be included in a compliant bitstream.

### SUMMARY OF INVENTION

In general, this disclosure describes various techniques for coding video data. In particular, this disclosure describes techniques for adaptively clipping sample values. It should be noted that although techniques of this disclosure are described with respect to ITU-T H.264, ITU-T H.265, and JEM, the techniques of this disclosure are generally applicable to video coding. For example, the coding techniques described herein may be incorporated into video coding systems, (including video coding systems based on future video coding standards) including block structures, intra prediction techniques, inter prediction techniques, transform techniques, filtering techniques, and/or entropy coding techniques other than those included in ITU-T H.265 and JEM. Thus, reference to ITU-T H.264, ITU-T H.265, and/or JEM is for descriptive purposes and should not be construed to limit the scope of the techniques described herein. Further, it should be noted that incorporation by reference of documents herein is for descriptive purposes and should not be construed to limit or create ambiguity with respect to terms used herein. For example, in the case where an incorporated reference provides a different definition of a term than another incorporated reference and/or as the term is used herein, the term should be interpreted in a manner that broadly includes each respective definition and/or in a manner that includes each of the particular definitions in the alternative.

An aspect of the invention is a method of clipping sample values, the method comprising: receiving sample values for a component of video data; for one or more sub-divisions of the video data, determining a sample value limit; setting a bound of a clipping function based on the determined sample value limit; and modifying reconstructed video blocks based on the clipping function.

An aspect of the invention is a method of clipping video sample values, the method comprising: receiving reconstructed video blocks for a component of video data; determining a bound of a clipping function; and modifying reconstructed video blocks based on the clipping function.

### BRIEF DESCRIPTION OF DRAWINGS

FIG. 1 is a block diagram illustrating an example of a system that may be configured to encode and decode video data according to one or more techniques of this disclosure.

FIG. 2 is a block diagram illustrating an example of a video encoder that may be configured to encode video data according to one or more techniques of this disclosure.

FIG. 3 is a conceptual diagram illustrating an example of a reconstructed video data in accordance with one or more techniques of this disclosure.

FIG. 4 is a block diagram illustrating an example of a video decoder that may be configured to decode video data according to one or more techniques of this disclosure.

### DESCRIPTION OF EMBODIMENTS

Video content typically includes video sequences comprised of a series of frames. A series of frames may also be referred to as a group of pictures (GOP). Each video frame or picture may include a plurality of slices or tiles, where a slice or tile includes a plurality of video blocks. As used herein, the term video block may generally refer to an area of a picture, including one or more video components, or may more specifically refer to the largest array of pixel/sample values that may be predictively coded, sub-divisions thereof, and/or corresponding structures. Further, the term current video block may refer to an area of a picture being encoded or decoded. A video block may be defined as an array of pixel values (also referred to as samples) that may be predictively coded. Video blocks may be ordered according to a scan pattern (e.g., a raster scan). A video encoder may perform predictive encoding on video blocks and sub-divisions thereof. Video blocks and sub-divisions thereof may be referred to as nodes. ITU-T H.264 specifies a macroblock including 16×16 luma samples. ITU-T H.265 specifies an analogous Coding Tree Unit (CTU) structure where a picture may be split into CTUs of equal size and each CTU may include Coding Tree Blocks (CTB) having 16×16, 32×32, or 64×64 luma samples. In ITU-T H.265, the CTBs of a CTU may be partitioned into Coding Blocks (CB) according to a corresponding quadtree block structure. According to ITU-T H.265, one luma CB together with two corresponding chroma CBs (e.g., Cr and Cb chroma components) and associated syntax elements are referred to as a coding unit (CU). In ITU-T H.265, a minimum allowed size of a CB may be signaled. In ITU-T H.265, the smallest minimum allowed size of a luma CB is 8×8 luma samples. A CU is associated with a prediction unit (PU) structure defining one or more prediction units (PU) for the CU, where a PU is associated with corresponding reference samples. That is, in ITU-T H.265, the decision to code a picture area using intra prediction or inter prediction is made at the CU level. In ITU-T H.265, a PU may include luma and chroma prediction blocks (PBs), where square PBs are supported for intra prediction and rectangular PBs are supported for inter prediction. Intra prediction data (e.g., intra prediction mode syntax elements) or inter prediction data (e.g., motion data syntax elements) may associate PUs with corresponding reference samples.

JEM specifies a CTU having a maximum size of 256×256 luma samples. In JEM, CTUs may be further partitioned according a quadtree plus binary tree (QTBT) block structure. In JEM, the QTBT structure enables quadtree leaf nodes to be further partitioned by a binary tree structure. In JEM, the binary tree structure enables quadtree leaf nodes to be divided vertically or horizontally. Thus, the binary tree structure in JEM enables square and rectangular leaf nodes, where each leaf node includes a Coding Block (CB) for each component of video data. In JEM, CBs may be used for prediction without any further partitioning. Further, in JEM, luma and chroma components may have separate QTBT structures. That is, chroma CBs may be independent of luma partitioning. In JEM, separate QTBT structures are enabled for slices of video data coded using intra prediction techniques.

A video sampling format, which may also be referred to as a chroma format, may define the number of chroma samples included in a CU with respect to the number of luma samples included in a CU. For example, for the 4:2:0 format, the sampling rate for the luma component is twice that of the chroma components for both the horizontal and vertical directions. As a result, for a CU formatted according to the 4:2:0 format, the width and height of an array of samples for the luma component are twice that of each array of samples for the chroma components. As described above, a CU is typically defined according to the number of horizontal and vertical luma samples. Thus, a 16×16 CU formatted according to the 4:2:0 sample format includes 16×16 samples of luma components and 8×8 samples for each chroma component. Similarly, for a CU formatted according to the 4:2:2 format, the width of an array of samples for the luma component is twice that of the width of an array of samples for each chroma component, but the height of the array of samples for the luma component is equal to the height of an array of samples for each chroma component. Further, for a CU formatted according to the 4:4:4 format, an array of samples for the luma component has the same width and height as an array of samples for each chroma component.

The difference between sample values included in a current CU, or another type of picture area structure, and associated reference samples (e.g., those generated using a prediction) may be referred to as residual data. Residual data may include respective arrays of difference values corresponding to each component of video data (e.g., luma (Y) and chroma (Cb and Cr). Residual data may be in the pixel domain. It should be noted that associated reference samples may be generated in some cases by simply inheriting sample values identified using a prediction (e.g., using corresponding sample values from a reference picture) and in some cases associated reference samples may be generated by modifying sample values identified using a prediction (e.g., weighted sample values) or modifying default sample values (e.g., when predictive data is not available). In some cases, the modification of sample values may result in reference sample values having values outside the bounds provided by a bit-depth specified for a component of video data. For example, if a bit-depth of 10 is specified for a luma component of video data, the range of possible values for samples is 0 to 1023 (i.e., 2¹⁰=1024). In this example, if an associated reference sample value is generated by adding an offset to a referenced sample value, the resulting associated reference sample value may be greater than the maximum sample value provided by the bit-depth. For example, if a sample value is 1000 and an offset is 56, the associated reference sample value would be 1056, which would be greater than the value of 1023 provided by a bit-depth of 10. ITU-T H.265 and JEM provide where reference sample values outside of the range provided by a bit-depth may be clipped as follows:

S′=Clip(Min,Max,S);

where,
S is the input sample value,
S′ is the output sample value,
Min is the minimum allowed sample value,
Max is the maximum allowed sample value, and
Clip (x, y, z), returns z, if x<z<y,
   returns x, if z is less than or equal to x, or
   returns y, if z is greater than or equal to y.

ITU-T H.265 and JEM, Min is equal to 0 and Max is equal to 2^{bit-depth}−1.

A transform, such as, a discrete cosine transform (DCT), a discrete sine transform (DST), an integer transform, a wavelet transform, or a conceptually similar transform, may be applied to pixel difference values to generate transform coefficients. It should be noted that in ITU-T H.265, CUs may be further sub-divided into Transform Units (TUs). That is, in ITU-T H.265, an array of pixel difference values may be sub-divided for purposes of generating transform coefficients (e.g., four 8×8 transforms may be applied to a 16×16 array of residual values), for each component of video data, such sub-divisions may be referred to as Transform Blocks (TBs). Currently in JEM, when a QTBT partitioning structure is used, residual values corresponding to a CB are used to generate transform coefficients without further partitioning. That is, in JEM a QTBT leaf node may be analogous to both a PB and TB in ITU-T H.265. Thus, JEM enables rectangular CB predictions for intra and inter predictions. Further, in JEM, a core transform and a subsequent secondary transforms may be applied (in the encoder) to generate transform coefficients. For a video decoder, the order of transforms is reversed. Further, in JEM, whether a secondary transform is applied to generate transform coefficients may be dependent on a prediction mode.

A quantization process may be performed on transform coefficients. Quantization scales transform coefficients in order to vary the amount of data required to send a group of transform coefficients. Quantization may include division of transform coefficients by a quantization scaling factor and any associated rounding functions (e.g., rounding to the nearest integer). Quantized transform coefficients may be referred to as coefficient level values or simply level values. Inverse quantization (or “dequantization”) may include multiplication of coefficient level values by the quantization scaling factor. It should be noted that, as used herein, the term quantization process in some instances may refer to division by a quantization scaling factor to generate level values and multiplication by a quantization scaling factor to recover transform coefficients in some instances. That is, a quantization process may refer to quantization in some cases and inverse quantization in some cases. In ITU-T H.265, the value of a quantization scaling factor (referred to as Qₛₜₑₚ in ITU-T H.265) may be determined by a quantization parameter (QP). It should be noted that as used herein the term quantization parameter may be used to refer generally to a parameter used to determining values for quantization (e.g., quantization scaling factors) and/or may be used to more specifically refer to a specific implementation of a quantization parameter (e.g., Qp′ y in ITU-T H.265). In ITU-T H.265, the quantization parameter can take 52 values from 0 to 51 and a change of 1 for the quantization parameter generally corresponds to a change in the value of the Qₛₜₑₚ by approximately 12%.

Quantized transform coefficients and related data may be entropy coded according to an entropy encoding technique (e.g., content adaptive variable length coding (CAVLC), context adaptive binary arithmetic coding (CABAC), probability interval partitioning entropy coding (PIPE), etc.). Further, syntax elements, such as, a syntax element indicating a prediction mode, may also be entropy coded. Entropy encoded quantized transform coefficients and corresponding entropy encoded syntax elements may form a compliant bitstream that can be used to reproduce video data. A binarization process may be performed on syntax elements as part of an entropy coding process. Binarization refers to the process of converting a syntax value into a series of one or more bits. These bits may be referred to as “bins.” Binarization is a lossless process and may include one or a combination of the following coding techniques: fixed length coding, unary coding, truncated unary coding, truncated Rice coding, Golomb coding, k-th order exponential Golomb coding, and Golomb-Rice coding. As used herein each of the terms fixed length coding, unary coding, truncated unary coding, truncated Rice coding, Golomb coding, k-th order exponential Golomb coding, and Golomb-Rice coding may refer to general implementations of these techniques and/or more specific implementations of these coding techniques. For example, a Golomb-Rice coding implementation may be specifically defined according to a video coding standard, for example, ITU-T H.265. After binarization, a CABAC entropy encoder may select a context model. For a particular bin, a context model may be selected from a set of available context models associated with the bin. In some examples, a context model may be selected based on a previous bin and/or values of previous syntax elements. For example, a context model may be selected based on the value of a neighboring intra prediction mode. A context model may identify the probability of a bin being a particular value. For instance, a context model may indicate a 0.7 probability of coding a 0-valued bin and a 0.3 probability of coding a 1-valued bin. After selecting an available context model, a CABAC entropy encoder may arithmetically code a bin based on the identified context model. It should be noted that some syntax elements may be entropy encoded using arithmetic encoding without the usage of an explicitly assigned context model, such coding may be referred to as bypass coding.

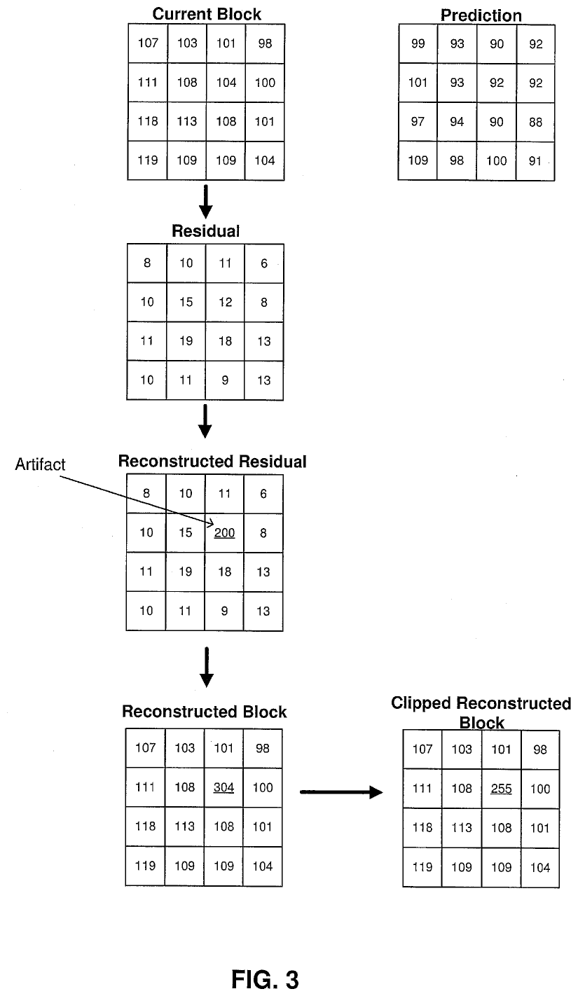

As described above, residual data may be encoded as an array of quantized transform coefficients. A reciprocal inverse quantization process and an inverse transform may be applied to an array of quantized transform coefficients to generate reconstructed residual data. Reconstructed residual data may be added to a predictive video block to generate a reconstructed video block. The generation of a reconstructed video block may occur during a decoding process or during an encoding process. For example, during encoding, a resulting reconstructed video block may be used to evaluate the encoding quality for a given prediction, transform type, and/or level of quantization and used as predictive video block for subsequently encoded video blocks. In a manner similar to that described above with respect to associated reference sample values, in some cases, the addition of reconstructed residual data to a predictive video block may result in a reconstructed video block having sample values outside of the range provided by a bit-depth. For example, the process of performing a transform and a corresponding inverse transform on residual data may result in artifacts being present in residual data. Artifacts in reconstructed residual data may cause a reconstructed video block to have sample values outside of the range provided by a bit-depth. In ITU-T H.265 and JEM, reconstructed video blocks are clipped to range provided by a bit-depth, i.e., Min is equal to 0 and Max is equal to 2^{bitdepth}−1. FIG. 3 illustrates an example where a reconstructed residual includes an artifact and the resulting sample value in the reconstructed block is clipped to the maximum allowed value (i.e., 2⁸−1, for an 8-bit depth) to remove the artifact.

Further, in some cases, reconstructed video data may be filtered. For example, de-blocking (or de-blocking), deblock filtering, or applying a deblocking filter may be used to smooth the boundaries of neighboring reconstructed video blocks (i e, making boundaries less perceptible to a viewer). Smoothing the boundaries of neighboring reconstructed video blocks may include modifying sample values included in rows or columns adjacent to a boundary. Further, Sample Adaptive Offset (SAO) is a nonlinear amplitude mapping that may be used to improve reconstruction by adding an offset to reconstructed video data. The filtering of reconstructed video data may result in a filter (or modified) reconstructed video block having sample values outside of the range provided by a bit-depth. In ITU-T H.265 and JEM, filtered reconstructed video blocks are clipped to range provided by a bit-depth, i.e., Min is equal to 0 and Max is equal to 2^{bitdepth}−1.

F. Galpin, et al., “Adaptive Clipping in JEM 2.0,” 3^{rd} Meeting: Geneva, CH, 26 May-Jun. 1, 2016, Doc. JVET-00040r3 (hereinafter “Galpin”), describes where a video encoder, for each component of each slice of video data, computes the values used to clip sample values (i.e., Min and Max) as the respective minimum and maximum sample values of an input picture. In Galpin, adjustments to Min and Max based on an internal bitdepth (i.e., 0 and 2^{bitdepth}−1) are signaled in the bitstream. In Galpin, the adjustments may be signaled using an intra signaling technique where fixed length adjustment values (i.e., minY, maxY, minCb, maxCb, minCr, and maxCr) are signaled in a Picture Parameter Set (PPS) or a slice header. Further, Galpin provides a predictive signaling technique, where a Variable Length Coded (VLC) value, signaled at a slice level, adjusts reference clipping bounds included in a reference picture with the closest Picture Order Count (POC). Thus, in Galpin, Min and Max may only be adjusted per slice of video data. Further, Galpin provides where in every step of the codec where a clipping is performed between 0 and 2^{bitdepth}−1 adaptive clipping is used. Thus, in Galpin, when the adaptive clipping technique is enabled, for a slice of video data, the lower and upper bounds used for clipping are the same for clipping of reference sample values, sample values in reconstructed video blocks, and sample values in filtered reconstructed video blocks in a slice of video data. Further, the lower and upper bounds are determined as the minimum and maximum values provided in an input picture. Such adaptive clipping may be less than ideal.

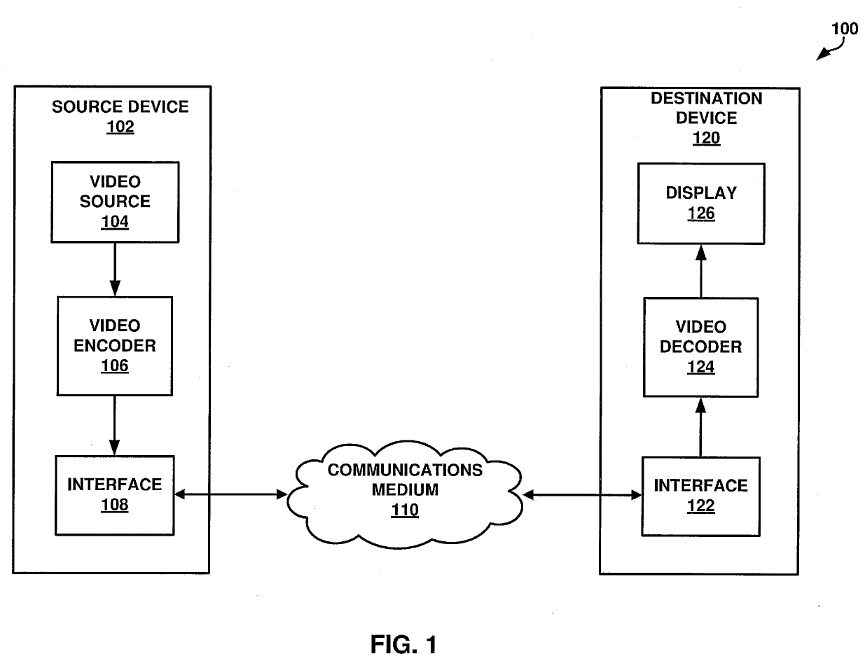

FIG. 1 is a block diagram illustrating an example of a system that may be configured to code (i.e., encode and/or decode) video data according to one or more techniques of this disclosure. System 100 represents an example of a system that may adaptively clip sample values according to one or more techniques of this disclosure. As illustrated in FIG. 1, system 100 includes source device 102, communications medium 110, and destination device 120. In the example illustrated in FIG. 1, source device 102 may include any device configured to encode video data and transmit encoded video data to communications medium 110. Destination device 120 may include any device configured to receive encoded video data via communications medium 110 and to decode encoded video data. Source device 102 and/or destination device 120 may include computing devices equipped for wired and/or wireless communications and may include set top boxes, digital video recorders, televisions, desktop, laptop, or tablet computers, gaming consoles, mobile devices, including, for example, “smart” phones, cellular telephones, personal gaming devices, and medical imaging devices.

Communications medium 110 may include any combination of wireless and wired communication media, and/or storage devices. Communications medium 110 may include coaxial cables, fiber optic cables, twisted pair cables, wireless transmitters and receivers, routers, switches, repeaters, base stations, or any other equipment that may be useful to facilitate communications between various devices and sites. Communications medium 110 may include one or more networks. For example, communications medium 110 may include a network configured to enable access to the World Wide Web, for example, the Internet. A network may operate according to a combination of one or more telecommunication protocols. Telecommunications protocols may include proprietary aspects and/or may include standardized telecommunication protocols. Examples of standardized telecommunications protocols include Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, Global System Mobile Communications (GSM) standards, code division multiple access (CDMA) standards, 3rd Generation Partnership Project (3GPP) standards, European Telecommunications Standards Institute (ETSI) standards, Internet Protocol (IP) standards, Wireless Application Protocol (WAP) standards, and Institute of Electrical and Electronics Engineers (IEEE) standards.

Storage devices may include any type of device or storage medium capable of storing data. A storage medium may include a tangible or non-transitory computer-readable media. A computer readable medium may include optical discs, flash memory, magnetic memory, or any other suitable digital storage media. In some examples, a memory device or portions thereof may be described as non-volatile memory and in other examples portions of memory devices may be described as volatile memory. Examples of volatile memories may include random access memories (RAM), dynamic random access memories (DRAM), and static random access memories (SRAM). Examples of non-volatile memories may include magnetic hard discs, optical discs, floppy discs, flash memories, or forms of electrically programmable memories (EPROM) or electrically erasable and programmable (EEPROM) memories. Storage device(s) may include memory cards (e.g., a Secure Digital (SD) memory card), internal/external hard disk drives, and/or internal/external solid state drives. Data may be stored on a storage device according to a defined file format.

Referring again to FIG. 1, source device 102 includes video source 104, video encoder 106, and interface 108. Video source 104 may include any device configured to capture and/or store video data. For example, video source 104 may include a video camera and a storage device operably coupled thereto. Video encoder 106 may include any device configured to receive video data and generate a compliant bitstream representing the video data. A compliant bitstream may refer to a bitstream that a video decoder can receive and reproduce video data therefrom. Aspects of a compliant bitstream may be defined according to a video coding standard. When generating a compliant bitstream, video encoder 106 may compress video data. Compression may be lossy (discernible or indiscernible) or lossless. Interface 108 may include any device configured to receive a compliant video bitstream and transmit and/or store the compliant video bitstream to a communications medium. Interface 108 may include a network interface card, such as an Ethernet card, and may include an optical transceiver, a radio frequency transceiver, or any other type of device that can send and/or receive information. Further, interface 108 may include a computer system interface that may enable a compliant video bitstream to be stored on a storage device. For example, interface 108 may include a chipset supporting Peripheral Component Interconnect (PCI) and Peripheral Component Interconnect Express (PCIe) bus protocols, proprietary bus protocols, Universal Serial Bus (USB) protocols, I²C, or any other logical and physical structure that may be used to interconnect peer devices.

Referring again to FIG. 1, destination device 120 includes interface 122, video decoder 124, and display 126. Interface 122 may include any device configured to receive a compliant video bitstream from a communications medium. Interface 108 may include a network interface card, such as an Ethernet card, and may include an optical transceiver, a radio frequency transceiver, or any other type of device that can receive and/or send information. Further, interface 122 may include a computer system interface enabling a compliant video bitstream to be retrieved from a storage device. For example, interface 122 may include a chipset supporting PCI and PCIe bus protocols, proprietary bus protocols, USB protocols, I²C, or any other logical and physical structure that may be used to interconnect peer devices. Video decoder 124 may include any device configured to receive a compliant bitstream and/or acceptable variations thereof and reproduce video data therefrom. Display 126 may include any device configured to display video data. Display 126 may comprise one of a variety of display devices such as a liquid crystal display (LCD), a plasma display, an organic light emitting diode (OLED) display, or another type of display. Display 126 may include a High Definition display or an Ultra High Definition display. It should be noted that although in the example illustrated in FIG. 1, video decoder 124 is described as outputting data to display 126, video decoder 124 may be configured to output video data to various types of devices and/or sub-components thereof. For example, video decoder 124 may be configured to output video data to any communication medium, as described herein.

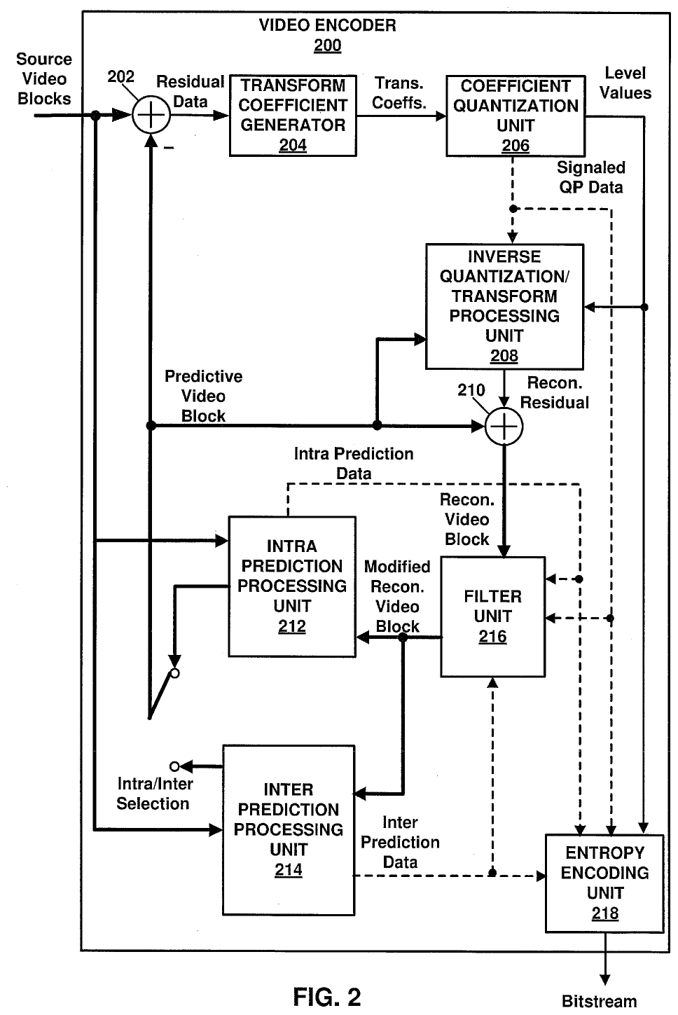

FIG. 2 is a block diagram illustrating an example of video encoder 200 that may implement the techniques for encoding video data described herein. It should be noted that although example video encoder 200 is illustrated as having distinct functional blocks, such an illustration is for descriptive purposes and does not limit video encoder 200 and/or sub-components thereof to a particular hardware or software architecture. Functions of video encoder 200 may be realized using any combination of hardware, firmware, and/or software implementations. In one example, video encoder 200 may be configured to encode video data according to the techniques described herein. Video encoder 200 may perform intra prediction coding and inter prediction coding of picture areas, and, as such, may be referred to as a hybrid video encoder. In the example illustrated in FIG. 2, video encoder 200 receives source video blocks. In some examples, source video blocks may include areas of picture that has been divided according to a coding structure. For example, source video data may include macroblocks, CTUs, CBs, sub-divisions thereof, and/or another equivalent coding unit. In some examples, video encoder may be configured to perform additional sub-divisions of source video blocks. It should be noted that the techniques described herein are generally applicable to video coding, regardless of how source video data is partitioned prior to and/or during encoding. In the example illustrated in FIG. 2, video encoder 200 includes summer 202, transform coefficient generator 204, coefficient quantization unit 206, inverse quantization/transform processing unit 208, summer 210, intra prediction processing unit 212, inter prediction processing unit 214, filter unit 216, and entropy encoding unit 218. As illustrated in FIG. 2, video encoder 200 receives source video blocks and outputs a bitstream.

In the example illustrated in FIG. 2, video encoder 200 may generate residual data by subtracting a predictive video block from a source video block. Summer 202 represents a component configured to perform this subtraction operation. In one example, the subtraction of video blocks occurs in the pixel domain. Transform coefficient generator 204 applies a transform, such as a discrete cosine transform (DCT), a discrete sine transform (DST), or a conceptually similar transform, to the residual block or sub-divisions thereof (e.g., four 8×8 transforms may be applied to a 16×16 array of residual values) to produce a set of residual transform coefficients. Transform coefficient generator 204 may be configured to perform any and all combinations of the transforms included in the family of discrete trigonometric transforms. Transform coefficient generator 204 may output transform coefficients to coefficient quantization unit 206.

Coefficient quantization unit 206 may be configured to perform quantization of the transform coefficients. As described above, the degree of quantization may be modified by adjusting a quantization scaling factor which may be determined by quantization parameters. Coefficient quantization unit 206 may be further configured to determine quantization values and output QP data that may be used by a video decoder to reconstruct a quantization parameter (and thus a quantization scaling factor) to perform inverse quantization during video decoding. For example, signaled QP data may include QP delta values. In ITU-T H.265, the degree of quantization applied to a set of transform coefficients may depend on slice level parameters, parameters inherited from a previous coding unit, and/or optionally signaled CU level delta values.

As illustrated in FIG. 2, quantized transform coefficients are output to inverse quantization/transform processing unit 208. Inverse quantization/transform processing unit 208 may be configured to apply an inverse quantization and/or an inverse transformation to generate reconstructed residual data. As illustrated in FIG. 2, at summer 210, reconstructed residual data may be added to a predictive video block. In this manner, an encoded video block may be reconstructed and the resulting reconstructed video block may be used to evaluate the encoding quality for a given quality for a given prediction, transformation type, and/or level of quantization. Video encoder 200 may be configured to perform multiple coding passes (e.g., perform encoding while varying one or more coding parameters). The rate-distortion of a bitstream or other system parameters may be optimized based on evaluation of reconstructed video blocks. Further, reconstructed video blocks may be stored and used as reference for predicting subsequent blocks.

As described above, a video block may be coded using an intra prediction. Intra prediction processing unit 212 may be configured to select an intra prediction mode for a video block to be coded. Intra prediction processing unit 212 may be configured to evaluate a frame and/or an area thereof and determine an intra prediction mode to use to encode a current block. As illustrated in FIG. 2, intra prediction processing unit 212 outputs intra prediction data (e.g., syntax elements) to filter unit 216 and entropy encoding unit 218. In ITU-T H.265, defined possible intra prediction modes include a planar (i.e., surface fitting) prediction mode (predMode: 0), a DC (i.e., flat overall averaging) prediction mode (predMode: 1), and 33 angular prediction modes (predMode: 2-34). In JEM, defined possible intra-prediction modes include a planar prediction mode (predMode: 0), a DC prediction mode (predMode: 1), and 65 angular prediction modes (predMode: 2-66). It should be noted that planar and DC prediction modes may be referred to as non-directional prediction modes and that angular prediction modes may be referred to as directional prediction modes. It should be noted that the techniques described herein may be generally applicable regardless of the number of defined possible prediction modes. Further, in some examples, a prediction for a chroma component may be inferred from an intra prediction for a luma prediction mode.

Inter prediction processing unit 214 may be configured to perform inter prediction coding for a current video block. Inter prediction processing unit 214 may be configured to receive source video blocks and calculate a motion vector for PUs, or the like, of a video block. A motion vector may indicate the displacement of a PU, or the like, of a video block within a current video frame relative to a predictive block within a reference frame. Inter prediction coding may use one or more reference pictures. Further, motion prediction may be uni-predictive (use one motion vector) or bi-predictive (use two motion vectors). Inter prediction processing unit 214 may be configured to select a predictive block by calculating a pixel difference determined by, for example, sum of absolute difference (SAD), sum of square difference (SSD), or other difference metrics. A motion vector and associated data may describe, for example, a horizontal component of the motion vector, a vertical component of the motion vector, a resolution for the motion vector (e.g., one-quarter pixel precision), a prediction direction and/or a reference picture index value. Further, a coding standard, such as, for example ITU-T H.265, may support motion vector prediction. Motion vector prediction enables a motion vector to be specified using motion vectors of neighboring blocks. Examples of motion vector prediction include advanced motion vector prediction (AMVP), temporal motion vector prediction (TMVP), so-called “merge” mode, and “skip” and “direct” motion inference.

Further, JEM supports advanced temporal motion vector prediction (ATMVP), spatial-temporal motion vector prediction (STMVP), and advanced motion vector resolution (AMVR) mode. Further, JEM supports overlapped block motion compensation (OBMC). Thus, JEM utilizes advanced inter prediction modes compared to ITU-T H.265. In JEM OBMC divides a CB into sub-blocks for purposes of determining motion vector information for each sub-block. That is, if a motion vector is provided for a CB, OBMC allows for additional motion vector information to be provided for specific sub-blocks with the CB. For example, a CB having 128×128 samples may be divided into 4×4 sub-blocks and sub-blocks located at the boundary of the CB may include additional motion vector information. In some examples, additional motion vector information may be inherited from neighboring sub-blocks located in another CB. For example, a predictive block for a sub-block may be generated as a weighted average of predictive blocks associated with neighboring sub-blocks. Inter prediction processing unit 214 may be configured to perform motion vector prediction according to one or more of the techniques described above. Inter prediction processing unit 214 may be configured to generate a predictive block using the motion prediction data. For example, inter prediction processing unit 214 may locate a predictive video block within a frame buffer (not shown in FIG. 2). It should be noted that inter prediction processing unit 214 may further be configured to apply one or more interpolation filters to a reconstructed residual block to calculate sub-integer pixel values for use in motion estimation. Inter prediction processing unit 214 may output motion prediction data for a calculated motion vector to filter unit 216 and entropy encoding unit 218.

As illustrated in FIG. 2, filter unit 216 receives reconstructed video blocks and coding parameters and outputs modified reconstructed video data. Filter unit 216 may be configured to perform deblocking and/or Sample Adaptive Offset (SAO) filtering. It should be noted that as illustrated in FIG. 2, intra prediction processing unit 212 and inter prediction processing unit 214 may receive modified reconstructed video block via filter unit 216. That is, in some cases, deblocking may occur in-loop, i.e., predictive video blocks stored in a reference buffer may be filtered. In some cases, de-blocking may occur post-loop, i.e., after video data has been reconstructed and prior to being output to a display, for example. The techniques described herein are applicable in-loop deblocking, post-loop deblocking, and/or combinations thereof.

Referring again to FIG. 2, entropy encoding unit 218 receives quantized transform coefficients and predictive syntax data (i.e., intra prediction data, motion prediction data, QP data, etc.). It should be noted that in some examples, coefficient quantization unit 206 may perform a scan of a matrix including quantized transform coefficients before the coefficients are output to entropy encoding unit 218. In other examples, entropy encoding unit 218 may perform a scan. Entropy encoding unit 218 may be configured to perform entropy encoding according to one or more of the techniques described herein. Entropy encoding unit 218 may be configured to output a compliant bitstream, i.e., a bitstream that a video decoder can receive and reproduce video data therefrom.

As described above, artifacts in reconstructed residual data may cause a reconstructed video block to have sample values outside of the range provided by a bit-depth. In ITU-T H.265 and JEM, reconstructed video blocks are clipped to the range provided by a bit-depth. As further described above, Galpin describes where adaptive clipping may be enabled for a slice of video data, where the lower and upper bounds are determined as the minimum and maximum values provided in an input picture. Such clipping techniques may be less than ideal.

Video encoder 200 may be configured to perform adaptive clipping of sample values at one or more stages in a video encoding process according to the techniques described herein. For example, video encoder 200 may be configured to adaptively clip reference sample values, reconstructed sample values, and/or filtered reconstructed sample values. In one example, video encoder 200 may be configured to determine bounds provided by a bit-depth and determine respective bounds at one or more sub-divisions of a sequence of video data. That is, for one or more components of a current portion of video data, video encoder 200 may determine respective minimum and maximum sample values at a particular sub-division. In one example, video encoder 200 may be configured to perform single bound adaptive clipping. That is, one of the minimum bound or the maximum bound may be adaptive clipped. In one example, video encoder 200 may be configured to adaptively clip both the minimum bound and/or the maximum bound. In one example, video encoder 200 may be configured to perform adaptive clipping techniques independently for each component of video data.

Table 1 illustrates examples of minimum and maximum sample values for respective sub-divisions of video data. In the example illustrated in Table 1, the current CU may correspond to a relative bright area of a scene.

TABLE 1

| | | Current | Current | Current | Current | Current |
|---|---|---|---|---|---|---|
| | Bitdepth | Sequence | Picture | Slice | CTU | CU |
| Minimum | 0 | 4 | 400 | 500 | 586 | 602 |
| Value | | | | | | |
| Maximum | 1023 | 1000 | 1000 | 956 | 904 | 904 |
| Value | | | | | | |

In the example illustrated in Table 1, for each respective sub-division, the lower bound increases and the upper bound decreases as each sub-division occurs. However, it should be noted that areas within a picture may have different minimum sample values and maximum sample values. For example, one region of a picture may include a portion of a scene in a shadow and as such, may have a different dynamic range than a portion of a scene not in a shadow. Table 2 illustrates an example where a slice included in the same picture as the slice in Table 1 has different minimum sample value and maximum sample value.

TABLE 2

| | | Current | Current | Current | Current | Current |
|---|---|---|---|---|---|---|
| | Bitdepth | Sequence | Picture | Slice | CTU | CU |
| Minimum | 0 | 4 | 400 | 400 | 400 | 400 |
| Value | | | | | | |
| Maximum | 1023 | 1000 | 1000 | 700 | 600 | 500 |
| Value | | | | | | |

Video encoder 200 may be configured to perform adaptive clipping techniques based on respective bounds at one or more sub-divisions of a sequence of video data. That is, video encoder 200 may determine bounds for one or more sub-divisions of a sequence of video data. Based on the one or more determined bounds, video encoder 200 may enable adaptive clipping for one or more sub-divisions of a sequence of video data. Video encoder 200 may signal whether adaptive clipping is enabled for a sub-division of video data. For example, video encoder 200 may signal one or more of a sequence level flag (e.g., in a Sequence Parameter Set (SPS)), a picture level flag (e.g., in a Picture Parameter Set (PPS)), a slice-level flag (e.g., in a slice header), a CTU level flag and/or a CU (or CB) level flag indicating whether adaptive clipping is enabled. Upon receiving a flag indicating that adaptive clipping is enabled, a video decoder (e.g., video decoder 400) may determine Min and Max for the clipping function.

In one example, video encoder 200 may be configured to signal specific clipping values at a sequence level, a picture level, a slice-level, a CTU level, and/or a CU level. For example, video encoder 200 may be configured to signal Min and Max at a CTU level and signal a flag for each CU in the CTU to indicate whether adaptive clipping should be performed for the CU. In this manner, a video decoder receiving such signaling may determine whether adaptive clipping should be performed for a CU and when adaptive clipping is performed for the CU, determine Min and Max based on the Min and Max values signaled at the CTU level.

Further, in one example, video encoder 200 may be configured to signal Min and Max values at a slice level, signal Min and Max delta values at a CTU level, and signal a flag for each CU in a CTU. In this manner, a video decoder receiving such signaling may determine whether adaptive clipping should be performed for a CU and when adaptive clipping is performed for the CU, determine Min and Max based on the Min and Max values signaled at the slice level and the Min and Max delta values signaled at the CTU level.

In this manner, video encoder 200 may be configured to signal one or more of a sequence level flag, a picture level flag, a slice-level flag, a CTU level flag and/or a CU (or CB) level flag indicating whether adaptive clipping is enabled and/or signal specific clipping values at a sequence level, a picture level, a slice-level, a CTU level, and/or a CU level. For example, video encoder 200 may be configured to signal Min and Max at a slice level and signal a flag for each CTU in the slice to indicate whether adaptive clipping should be performed for the CTU. It should be noted that in some examples, flags at each level may be dependent on one another. For example, in one example, video encoder 200 may signal Min and Max values at one of a sequence, picture, or slice level. Video encoder 200 may also signal a flag at one of a sequence, picture, or slice level indicating whether CTU or CB flags are signaled. In this manner, adaptive clipping at a CTU or CB level may be selective enabled or disabled. Selective enabling or disabling clipping at a CTU or CB level may be useful for enabling low latency (i.e., “real-time”) encoding where clipping values are estimated prior to processing a current picture.

As described above, video encoder 200 may be configured to signal Min and Max delta values. It should be noted that video encoder 200 may be configured such that the Min and Max values may exist as predictive values and/or be updated (e.g., using delta value or local characteristics) at each of a sequence level, a picture level, a slice-level, a CTU level, and/or a CU level. Further, in one example, video encoder 200 may be configured to signal Min and Max values using index values. For example, tables may be defined for signaling Min and Max values. Table 3 illustrates an example of signaling Min and Max values for a bit depth of 10. Table 4 illustrates an example of signal delta values, where Min equals delta+0 and Max equals (2^{bitdepth}−1)−delta.

TABLE 3

| Index | 0 | 1 | 2 | 3 | 4 | 5 | 6 | 7 |
|---|---|---|---|---|---|---|---|---|
| Min | 8 | 16 | 24 | 32 | 64 | 128 | 256 | 512 |
| Max | 1000 | 948 | 932 | 924 | 712 | 628 | 564 | 512 |

TABLE 4

| Index | 0 | 1 | 2 | 3 | 4 | 5 | 6 | 7 |
|---|---|---|---|---|---|---|---|---|
| Delta | 8 | 16 | 24 | 32 | 64 | 100 | 128 | 256 |

It should be noted that in one example, a combination of index values may be used to indicate Min and/or Max. For example, a first index value may indicate a predictive Min or Max value and a second index value may indicate a delta value. In this case, Min may equal the predictive value+the delta value and Max may equal the predictive value−the delta value. It should be noted that in some examples whether a delta value is added or subtracted to a predictive value may be signaled. For example, if a predictive value is inherited from a higher sub-division it may not be necessary to signal whether addition or subtraction is performed. However, if a predictive value is inherited for a current CU from a neighboring CU one of addition or subtraction may be signaled. Further, it should be noted that in some examples, index values may be coded using the binarization techniques described above (e.g., k-th order exponential Golomb coding). It should be noted that in some examples, a video decoder may be configured to determine Min and Max based on values used for neighboring CBs and/or local sample value characteristics.

As described above, in some examples, video encoder 200 may be configured such that the Min and Max values may be updated at each of a sequence level, a picture level, a slice-level, a CTU level, and/or a CU level. For example, Min and Max values signaled for a slice may be updated for CTUs in the slice by signaling Min and Max delta values at a CTU level. In some examples, Min and Max delta values may be relative to an internal bit-depth. In other examples, Min and Max delta values may be relative to slice level Min and Max values. In some examples, flags may be used to indicate whether Min and Max delta values are signaled for a CTU. For example, for a first CTU in the slice, it may be desirable to only update a Max value and for a second CTU in a slice it may be desirable to only update a Min value. In one example, for each CTU in the slice, a flag, e.g., Clip_ctu_min_flag, may indicate whether a Min delta value is signaled for the CTU and a flag, e.g., Clip_ctu_max_flag, may indicate whether a Max delta value is signaled for the CTU. Thus, in some examples, the pair of flags Clip_ctu_min_flag and Clip_ctu_max_flag may be signaled for each CTU. In some examples, one of the flags Clip_ctu_min_flag and Clip_ctu_max_flag may be signaled for each CTU. For example, for a bright scene it may only be desirable to update the Max value. In one example, higher level signaling, e.g., slice level signaling may indicate whether the pair of flags (Clip_ctu_min_flag and Clip_ctu_max_flag), a single minimum flag (Clip_ctu_min_flag), or a single maximum flag (Clip_ctu_max_flag) is signaled for each CTU in the slice. As described above, a context model for entropy coding syntax elements may be selected based on a previous bin and/or values of previous syntax elements. In one example, flags Clip_ctu_min_flag and Clip_ctu_max_flag may be context coded and may share a context model.

It should be noted that in some examples, a Max delta value may be signaled as a difference with respect to the Min value (or a Min delta value). For example, in the case where a slice of video data has a Min value of 400 and a Max value of 700 and a current CTU has a Min value of 500 and a Max value of 595, a Min delta value of 100 may be signaled and a Max difference value of 5 may be signaled, where Max delta value=Min delta value+Max difference value. In one example, signaling a Max delta value as a Max difference value may be based on whether a Min delta value (or a Max delta) is greater than a threshold value. For example, in a case where a slice of video data has a Min value of 400 and a Max value of 700 and a current CTU has a Min value of 405 and a Max value of 650, a Min delta value of 5 may be signaled and a Max delta value of 50 may be signaled. In one other examples, signaling using a Max difference value may be based on the Min value and/or the Max value. For example, in a case where a slice of video data has a Min value of 400 and a Max value of 700 and a current CTU has a Min value of 500 and a Max value of 695, a Min delta value of 100 may be signaled and a Max delta value of 5 may be signaled (as opposed to a Max difference value of −95).

As described above, entropy coding may include binarization, the process of converting a syntax value into a series of one or more bits. In one example, the entropy coding and binarization of a Max difference value may be based on one or more of the Min Value, a signaled Min delta value, a Max value, a signaled Max delta value, and/or an internal bit-depth. For example, entropy coding of Max difference value may be based on whether a Min value is greater than the median value provided by an internal bit-depth (e.g., 512 for a bit-depth of 10). Further, in one example, entropy coding of Max difference value may be based on whether a slice level Max value is greater than the median value provided by an internal bit-depth. In other examples, other thresholds and Min values and Max values may be used to determining how entropy coding is performed. In some examples, a fixed length code binarization may be used if a difference value is within a range of 2^{N}. In some examples, a truncated binary code binarization may be used a difference value is outside a range of 2^{N}. In these examples, N may be an integer (e.g., 5, 6, 7, etc.). Further, in some examples, N may be a function of bitdepth. For example, N may equal bitdepth−2. In this case, if bitdepth equal 10, N equals 8 and 2^{N} equals 256. In some examples, an exponential golomb code binarization may be used and the order of the exponential golomb code may be based on whether the difference value is within a range. For example, relatively larger difference value may use relatively larger orders. It should be noted that in other examples, other combinations of binarizations may be performed on a difference value based on ranges. Further, it should be noted that in other examples, Min difference values may be used, e.g., Min delta value=Max delta value+Min difference value.

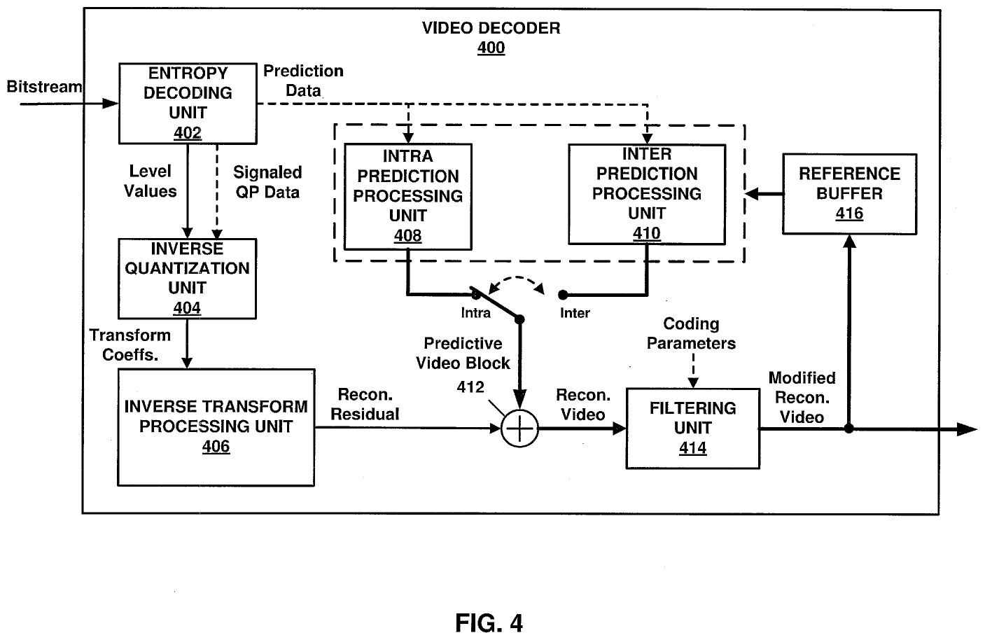

FIG. 4 is a block diagram illustrating an example of a video decoder that may be configured to decode video data according to one or more techniques of this disclosure. In one example, video decoder 400 may be configured to adaptively clip sample value based on one or more of the techniques described above. Video decoder 400 may be configured to perform intra prediction decoding and inter prediction decoding and, as such, may be referred to as a hybrid decoder. In the example illustrated in FIG. 4 video decoder 400 includes an entropy decoding unit 402, inverse quantization unit 404, inverse transform processing unit 406, intra prediction processing unit 408, inter prediction processing unit 410, summer 412, filter unit 414, reference buffer 416, and scaling unit 418. Video decoder 400 may be configured to decode video data in a manner consistent with a video encoding system, which may implement one or more aspects of a video coding standard. It should be noted that although example video decoder 400 is illustrated as having distinct functional blocks, such an illustration is for descriptive purposes and does not limit video decoder 400 and/or sub-components thereof to a particular hardware or software architecture. Functions of video decoder 400 may be realized using any combination of hardware, firmware, and/or software implementations.

As illustrated in FIG. 4, entropy decoding unit 402 receives an entropy encoded bitstream. Entropy decoding unit 402 may be configured to decode syntax elements and quantized coefficients from the bitstream according to a process reciprocal to an entropy encoding process. Entropy decoding unit 402 may be configured to perform entropy decoding according any of the entropy coding techniques described above. Entropy decoding unit 402 may parse an encoded bitstream in a manner consistent with a video coding standard.

Referring again to FIG. 4, inverse quantization unit 404 receives quantized transform coefficients (i.e., level values) and quantization parameter data from entropy decoding unit 402. Quantization parameter data may include any and all combinations of delta QP values and/or quantization group size values and the like described above. Video decoder 400 and/or inverse quantization unit 404 may be configured to determine quantization values used for inverse quantization based on values signaled by a video encoder and/or through video properties and/or coding parameters. That is, inverse quantization unit 404 may operate in a reciprocal manner to coefficient quantization unit 206 described above. Inverse quantization unit 404 may be configured to apply an inverse quantization. Inverse transform processing unit 406 may be configured to perform an inverse transformation to generate reconstructed residual data. The techniques respectively performed by inverse quantization unit 404 and inverse transform processing unit 406 may be similar to techniques performed by inverse quantization/transform processing unit 208 described above. Inverse transform processing unit 406 may be configured to apply an inverse DCT, an inverse DST, an inverse integer transform, Non-Separable Secondary Transform (NSST), or a conceptually similar inverse transform processes to the transform coefficients in order to produce residual blocks in the pixel domain. Further, as described above, whether particular transform (or type of particular transform) is performed may be dependent on an intra prediction mode. As illustrated in FIG. 4, reconstructed residual data may be provided to summer 412. Summer 412 may add reconstructed residual data to a predictive video block and generate reconstructed video data. A predictive video block may be determined according to a predictive video technique (i.e., intra prediction and inter frame prediction).

Intra prediction processing unit 408 may be configured to receive intra prediction syntax elements and retrieve a predictive video block from reference buffer 416. Reference buffer 416 may include a memory device configured to store one or more frames of video data. Intra prediction syntax elements may identify an intra prediction mode, such as the intra prediction modes described above. In one example, intra prediction processing unit 408 may reconstruct a video block using according to one or more of the intra prediction coding techniques describe herein. Inter prediction processing unit 410 may receive inter prediction syntax elements and generate motion vectors to identify a prediction block in one or more reference frames stored in reference buffer 416. Inter prediction processing unit 410 may produce motion compensated blocks, possibly performing interpolation based on interpolation filters. Identifiers for interpolation filters to be used for motion estimation with sub-pixel precision may be included in the syntax elements. Inter prediction processing unit 410 may use interpolation filters to calculate interpolated values for sub-integer pixels of a reference block. Filter unit 414 may be configured to perform filtering on reconstructed video data according to the techniques described herein. For example, filter unit 414 may be configured to perform deblocking and/or SAO filtering, Further, it should be noted that in some examples, filter unit 414 may be configured to perform proprietary discretionary filter (e.g., visual enhancements). As illustrated in FIG. 4, a reconstructed video block may be output by video decoder 400. In this manner, video decoder 400 may be configured adaptive clipping according to the techniques described herein.

As described above, a video encoder may be configured to signal syntax elements that allow the Min value and/or Max value used for clipping of sample values to be updated at each of a sequence level, a picture level, a slice-level, a CTU level, and/or a CU level. It should be noted that in some cases, signaling by a video encoder may result in a condition where the Max value is less than the Min value. For example, error in signaling, which may include errors due to quantization of syntax element, of one of the Max value or a Min value may cause the Max value be less than the Min value for a current CTU. For example, in the case where a slice of video data has a Min value of 400 and a Max value of 700 and a current CTU has a Min value of 500 and a Max value of 595, an erroneously signaled Min delta value of 200 may cause video decoder 400 to determine the current CTU has a Min value of 600 and a Max value of 595. In one example, video decoder 400 may be configured to determine whether a determined Min value is greater than or equal to a Max value. In one example, video decoder 400 may be configured to determine whether a determined Min value is within a range of a Max value. For example, video decoder 400 may be configured to determine if the determined Min value is within 2^{M} of the determined Max value, where M is an integer (e.g., 3, etc.). In these cases, where a determined Min value is greater than or equal to a Max value or within a range or the Max value, video decoder 400 may be configured to modify how clipping is performed. For example, in one example, video decoder 400 may be configured to set the Min value and Max value used for clipping to default values (e.g., 2^{bitdepth}−1). In some examples, video decoder 400 may be configured subtract an offset from the determined Min Value and/or add an offset to a determined Max Value. For example, an offset value C may be subtracted from the determined Min Value and added to the determined Max Value and the resulting values may be used for clipping sample values. In one example, an offset value C₁ may be subtracted from the determined Min Value and an offset value C₂ may be added to the determined Max Value. In some examples, offset values may be based on an internal bit-depth.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Moreover, each functional block or various features of the base station device and the terminal device used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

Various examples have been described. These and other examples are within the scope of the following claims.

<Overview>

In one example, a method of clipping sample values comprises receiving sample values for a component of video data, for one or more sub-divisions of the video data, determining a sample value limit, setting a bound of a clipping function based on the determined sample value limit, and modifying reconstructed video blocks based on the clipping function.

In one example, a device for video coding comprises one or more processors configured to receive sample values for a component of video data, for one or more sub-divisions of the video data, determine a sample value limit, set a bound of a clipping function based on the determined sample value limit, and modify reconstructed video blocks based on the clipping function.

In one example, a non-transitory computer-readable storage medium comprises instructions stored thereon that, when executed, cause one or more processors of a device to receive sample values for a component of video data, for one or more sub-divisions of the video data, determine a sample value limit, set a bound of a clipping function based on the determined sample value limit, and modify reconstructed video blocks based on the clipping function.

In one example, an apparatus comprises means for receiving sample values for a component of video data, means for determining a sample value limit for one or more sub-divisions of the video data, means for setting a bound of a clipping function based on the determined sample value limit, and means for modifying reconstructed video blocks based on the clipping function.

The details of one or more examples are set forth in the accompanying drawings and the description below. Unless explicitly stated otherwise, components and functions are optional and may be combined or subdivided, and operations may vary in sequence or may be combined or subdivided. Other features, objects, and advantages will be apparent from the description and drawings, and from the claims.

1. A method of clipping sample values, the method comprising:
receiving sample values for a component of video data;
for one or more sub-divisions of the video data, determining a sample value limit;
setting a bound of a clipping function based on the determined sample value limit; and
modifying reconstructed video blocks based on the clipping function.

2. The method of claim 1, further comprising signaling the bound of the clipping function.

3. The method of claim 2, wherein signaling the bound of the clipping function includes signaling a difference value between a minimum value and a maximum value.

4. The method of claim 2, wherein signaling the bound of the clipping function includes signaling a delta value.

5. The method of claim 4, where signaling a delta value includes signaling a delta value for a coding tree unit.

6. The method of claim 5, wherein signaling the bound of the clipping function includes signaling a flag indicating the presence of the delta value.

7. The method of claim 4, wherein signaling a delta value includes signaling a delta value for a coding block.

8. The method of claim 1, further comprising signaling a flag indicating whether reconstructed video blocks are modified based on the clipping function.

9. The method of claim 8, where signaling a flag includes signaling a flag for a coding tree unit.

10. The method of claim 8, where signaling a flag includes signaling a flag for a coding block.

11. The method of claim 1, wherein a sample value limit includes a minimum sample value, a maximum sample value, or a minimum sample value and a maximum sample value.

12. A method of clipping video sample values, the method comprising:
receiving reconstructed video blocks for a component of video data;
determining a bound of a clipping function; and
modifying reconstructed video blocks based on the clipping function.

13. The method of claim 12, wherein determining a bound of a clipping function includes determining a minimum bound and a maximum bound from slice level signaling, and wherein modifying reconstructed video blocks based on the clipping function includes conditionally modifying reconstructed video blocks included in a coding tree unit based on a flag signaled for the coding tree unit.

14. The method of claim 12, further comprising determining whether a determined minimum bound of a clipping function is greater than or equal to a determined maximum bound of the clipping function, and adjusting one or more of the determined minimum bound and the determined maximum bound based on whether the determined minimum bound is greater than or equal to a determined maximum bound, wherein adjusting one or more of the determined minimum bound and the determined maximum bound includes one or more of subtracting a default value from the determined minimum bound and adding a default value to the determined upper bound.

15. The method of claim 12, further comprising determining whether a determined minimum bound of a clipping function is within a threshold of a determined maximum bound of the clipping function, and adjusting one or more of the determined minimum bound and the determined maximum bound based on whether the determined minimum bound is greater than or equal to a determined maximum bound wherein adjusting one or more of the determined minimum bound and the determined maximum bound includes one or more of subtracting a default value from the determined minimum bound and adding a default value to the determined upper bound.

16. (canceled)

17. A device for coding video data, the device comprising one or more processors configured to perform any and all combinations of the step of claim 1.

18. The device of claim 17, wherein the device includes a video encoder.

19. The device of claim 17, wherein the device includes a video decoder.

20. (canceled)

21. (canceled)

22. A non-transitory computer-readable storage medium comprising instructions stored thereon that, when executed, cause one or more processors of a device for coding video data to perform any and all combinations of the steps of claim 1.
